(19) United States
(12) Patent Application Publication
(10) Pub. No.: US 2002/0188231 A1
(43) Pub. Date: Dec. 12, 2002

(54) Device for performing can sucking therapy

(76) Inventor: Shih-Ta Liu, Taoyuan city (TW)

Correspondence Address: TROJAN LAW OFFICES, 9250 WILSHIRE BLVD, SUITE 325, BEVERLY HILLS, CA, 90212

(21) Appl. No.: 09/879,525

(22) Filed: Jun. 11, 2001

(51) Int. Cl. A61H 7/00

(52) U.S. Cl. 601/6; 604/46

(57) ABSTRACT

A device for performing a can sucking therapy is provided. The device includes a can body having a first opening, a second opening and a third opening defined therein, an automatic sucking device connected to the can body and communicating with the first opening for drawing air from an interior of the can body to form a negative pressure state within the can body when the second opening is sealed against a portion of a body, a vibrator mounted on the can body for vibrating the can body, and a valve arranged in the third opening for preventing air from entering the interior of the can body when the valve is turned off and allowing air to enter the can body when the valve is turned on.

### FIELD OF THE INVENTION

The present invention relates to a device for performing a can sucking therapy, and more particularly to a device for performing a can sucking therapy by an automatic sucking device.

### BACKGROUND OF THE INVENTION

Several traditional Chinese therapies have been gradually accepted and affirmed in recent years. One of them is the can sucking therapy. The can sucking therapy has a history of 200 years in China. Generally, the traditional can sucking device for performing a can sucking therapy is capable of executing air-extracting function from a can body of the can sucking device by a handle. However, the can sucking device is not convenient in using and doesn't perform a vibrating function.

FIG. 1 is a conventional can sucking device for performing a can sucking therapy having a vibrating device added upon a can body of the can sucking device for performing a vibrating function. A can body 11 is sealed against a portion of a body and a handle 12 is used for pulling up air by a sucking pump 14 to form a semi-vacuum state (a negative pressure state) within the can body 11 via a connecting hose 13. Therefore, the body part covered by the can body 11 will be filled with blood so as to improve the blood circulation of the user so as to stimulate the metabolism of the tissue. In addition, a vibrator 15 is mounted on the can body 11 for vibrating the can body 11 to enhance the curative effect of the can sucking device.

FIG. 2 shows a schematically sectional view of the can sucking device in FIG. 1. A spring 22 is positioned inside the sucking pump 14. When the user pulls the handle 12 of the sucking device toward the direction A, an one-way valve 21 mounted on the can body 11 is turned on, and air will be sucked from the interior of the can body 11. When the user looses his hand of the handle 12, the handle 12 will be automatically pushed toward the direction B because of the spring 22.

The conventional can sucking device has several drawbacks as follows:

1. The connecting hose, sucking pump and handle are mounted on the conventional can sucking device and thus more space thereof is occupied.

2. The conventional can sucking device must be performed by other person and fails to be performed by oneself.

It is therefore tried by the applicant to deal with the above situations encountered in the prior art.

### SUMMARY OF THE INVENTION

It is therefore an object of the present invention to provide a device for performing a can sucking therapy by oneself.

It is another object of the present invention to provide the device for performing a can sucking therapy, wherein only little space is required.

According to an aspect of the present invention, the device for performing a can sucking therapy includes a can body having a first opening, a second opening and a third opening defined therein, an automatic sucking device connected to the can body and communicating with the first opening for drawing air from an interior of the can body to form a negative pressure state within the can body when the second opening is sealed against a portion of a body, a vibrator mounted on the can body for vibrating the can body, and a valve arranged in the third opening for preventing air from entering the interior of the can body when the valve is turned off and allowing air to enter the can body when the valve is turned on.

Preferably, the automatic sucking device further includes a first motor having a shaft, a first eccentric shaft connected to one end of the shaft for performing an eccentric motion when the shaft of the first motor is rotated, a sucking pump communicating with the first opening for drawing air from the interior of the can body to form the negative pressure state within the can body, and a rod connected between the first eccentric shaft and the sucking pump for driving the sucking pump to withdraw air from the interior of the can body.

Preferably, the vibrator is a second eccentric shaft connected to the first motor for vibrating the can body when the first motor is operated.

Preferably, the vibrator is a second eccentric shaft connected to a second motor for vibrating the can body when the second motor is operated.

Preferably, the device further includes a controller for controlling a vibrating frequency of the vibrator.

Preferably, the device further includes a power supply for supplying electricity to the automatic sucking device and the vibrator.

Preferably, the power supply is one of a battery and a commercial power supply.

Preferably, the automatic sucking device is capable of being taken off from the portion of the body when the valve is turned on.

Preferably, the can body further includes an one-way valve arranged in the first opening for preventing air from entering the interior of the can body so as to maintain the negative pressure state with the interior of the can body.

The present invention may best be understood through the following descriptions with reference to the accompanying drawings, in which:

### BRIEF DESCRIPTION OF THE DRAWINGS

FIG. 1 is a perspective diagram showing the structure of the device for performing the can sucking therapy according to the prior art;

FIG. 2 is a schematically sectional view showing the device in FIG. 1;

FIGS. 3(a) to 3(d) are schematic diagrams showing the device for performing the can sucking therapy according to a first preferred embodiment of the present invention

FIG. 4 is an exploded view showing the assembly of the device in FIG. 3(c);

FIGS. 5(a) to 5(b) are schematic diagrams showing the devices for performing the can sucking therapy according to a second preferred embodiment of the present invention;

FIG. 6 is a schematic diagram showing the operation of the can sucking therapy applied on the user's body according to the present invention; and

FIGS. 7(a) to 7(d) are schematic diagrams showing different kinds of can bodies according to the present invention.

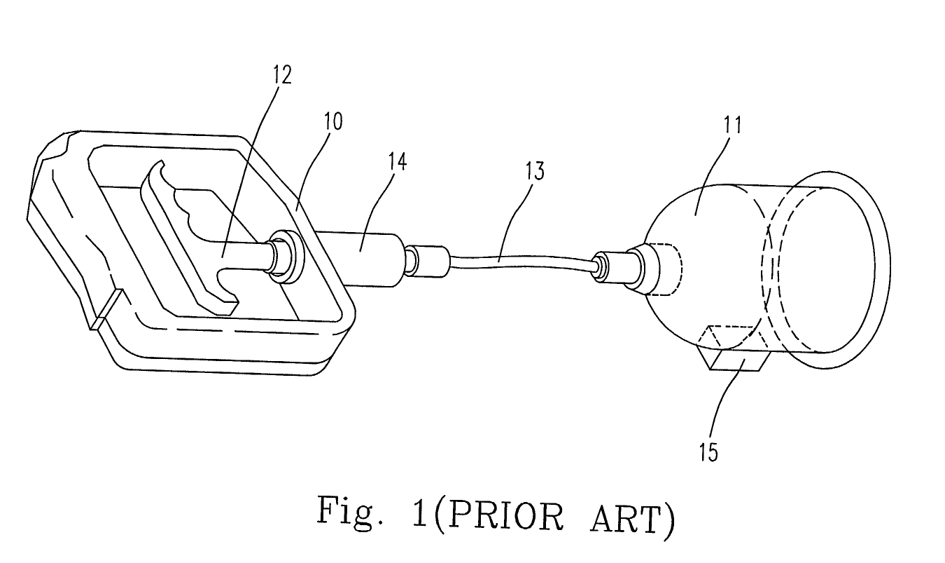

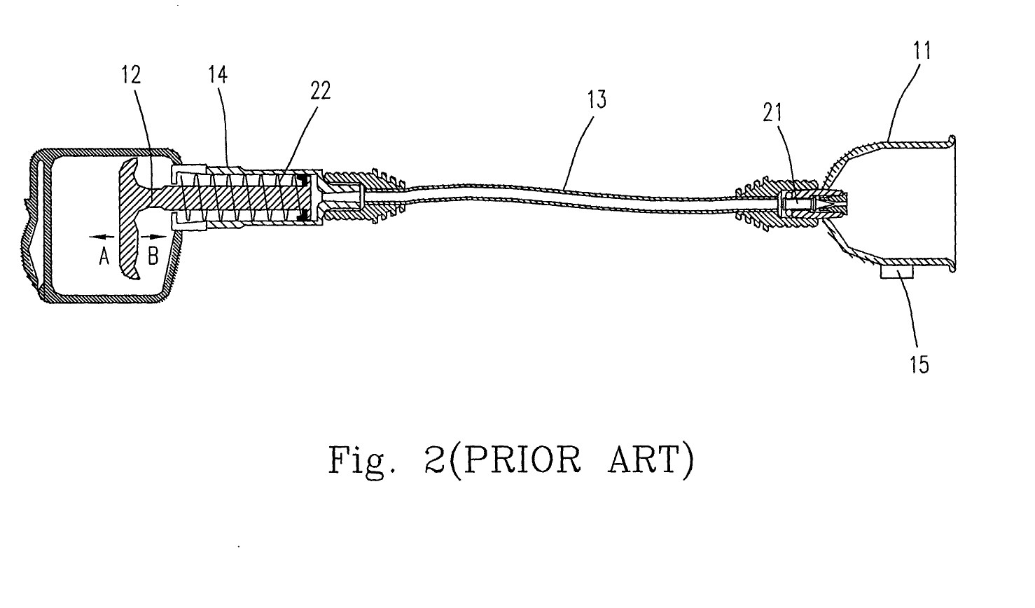

### DETAILED DESCRIPTION OF THE PREFERRED EMBODIMENT

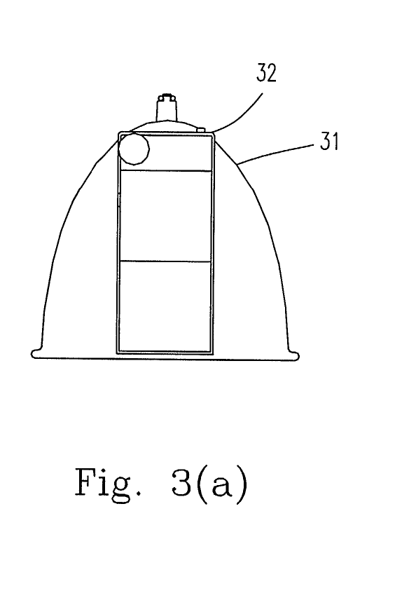

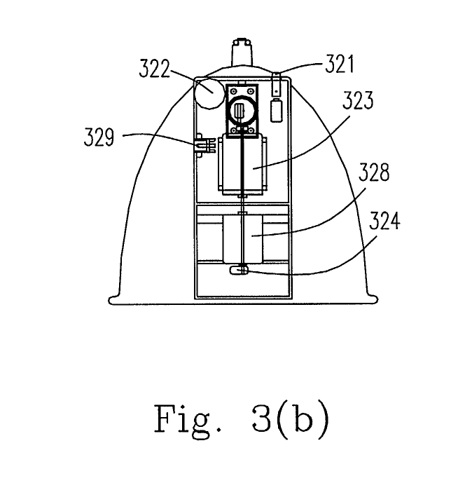

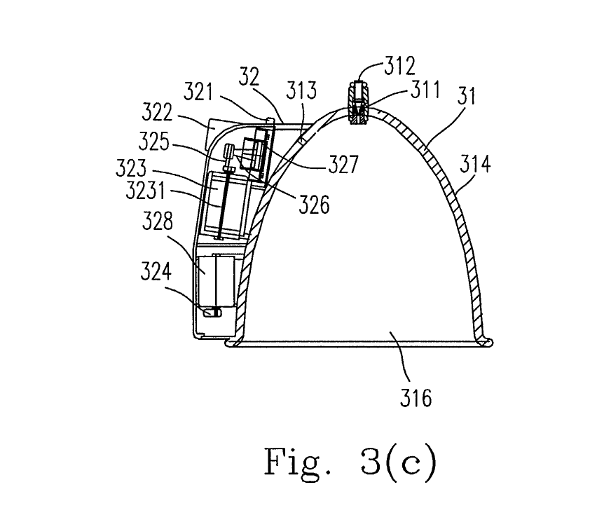

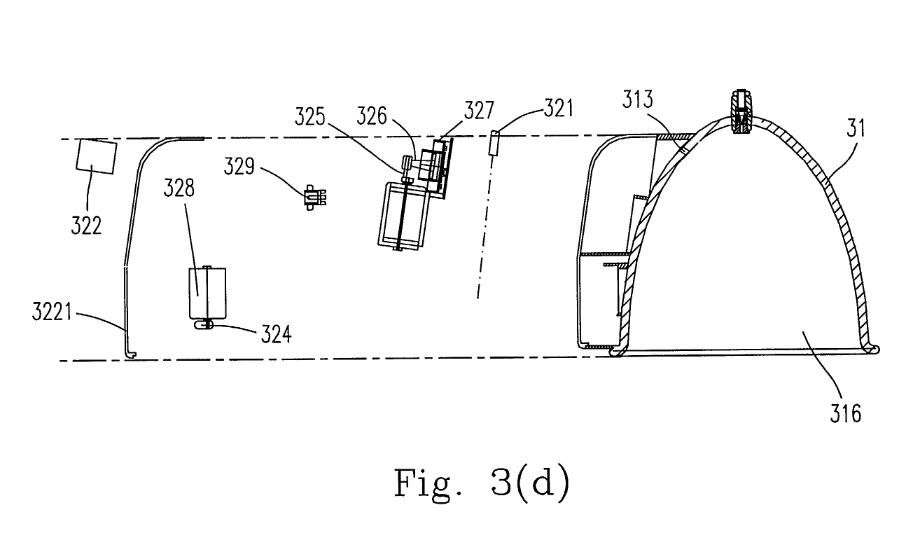

FIGS. 3(a) to 3(d) are views showing the device for performing the can sucking therapy according to the first preferred embodiment of the present invention. FIG. 3(a) is a front view showing the device for performing the can sucking therapy. FIG. 3(b) is a perspective view showing the device in FIG. 3(a). FIG. 3(c) is showing a sectional view the device in FIG. 3(b). FIG. 3(d) is showing an exploded view showing the assembly of the device in FIG. 3(c).

The device includes a main body 31 and a driving device 32. The main body 31 has a first opening 313 and a second opening 316 defined therein. The driving device 32 includes an automatic sucking device (not shown) and a vibrating device (not shown). The driving device 32 is connected to the main body 31 and is used to draw air inside the main body 31 to form a negative pressure state in the interior of the main body 31 and vibrating the main body 31 when the second opening 316 is sealed against a portion of a user's body (not shown).

The main body 31 includes a valve 312 and a can body 314. The can body 314 has three openings, i.e. the first opening 313, the second opening 316 and a third opening 311. The first opening 313 is equipped an one-way valve (not shown) for preventing air from entering the interior of the can body 314. Therefore, the negative pressure state within the can body 314 can be maintained when the second opening 316 is sealed against the portion of the user's body. The valve 312 is arranged in the third opening 311. When the can body 314 is tightly bound with the user's body, the user may feel uncomfortable. Then, the user can turn on the valve 312, and the interior pressure of the can body 314 is balanced after air enters the can body 314. The can body 314 can also be taken off from the portion of the use's body after the interior pressure is balanced.

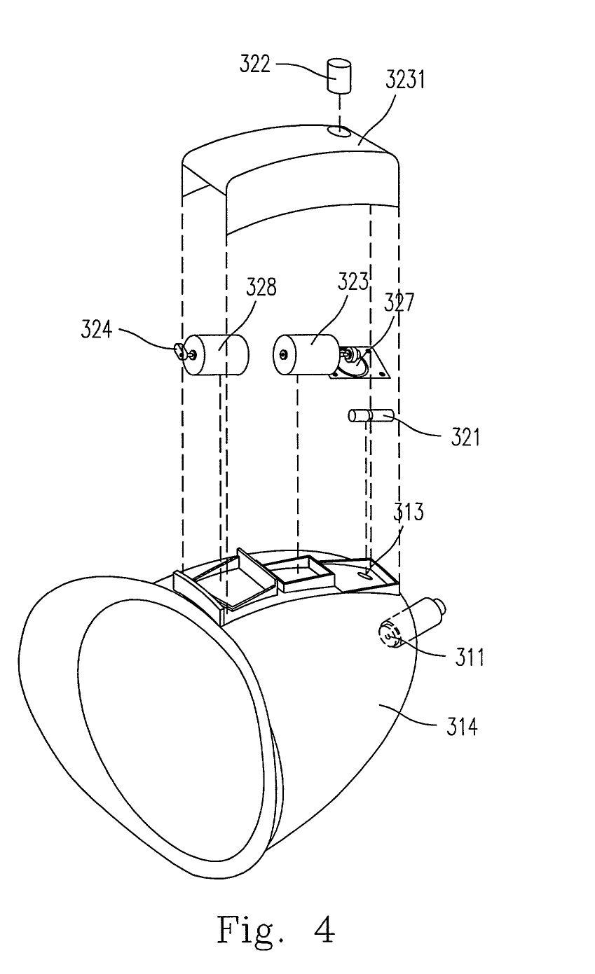

The automatic sucking device includes a first motor 323, a first eccentric shaft 325, a sucking pump 327 and a rod 326. The automatic sucking device is capable of being taken off from the portion of the user's body when the valve 312 is turned on. The first motor 323 has a shaft 3231 and the first eccentric shaft 325 is connected to one end of the shaft 3231. Thus, the first eccentric shaft 325 can perform an eccentric motion when the shaft 3231 is rotated. The rod 326 is connected between the first eccentric shaft 325 and the sucking pump 327. The rod 326 is used to drive the sucking pump 327 to draw the air within the main body 31 according to the eccentric motion of the first eccentric shaft 325. The exploded view of the driving device 32 can be seen in FIG. 4.

According to FIGS. 3(a) to 3(d) and 4, the vibrating device includes a second motor 328 and a second eccentric shaft 324 connected to the second motor 328. The main body 31 is vibrated because of the eccentric motion of the second eccentric shaft 324 when the second motor 328 is operated.

The driving device 32 includes an electric socket 329 for accepting electricity. The driving device 32 further includes a switch 321 arranged in the driving device 32 for switching on/off the operation of the first motor 323. When the switch 321 is turned on, the first motor 323 is also turned on and the sucking pump 327 will suck air within the can body 314.

The driving device further includes a controller 322 for controlling the vibrating frequency of the vibrating device. The controller 322 is electrically connected to a variable resistor (not shown). The electric current of the driving device 32 can be varied by adjusting the variable resistor. The rotating rate of the second motor 328 is changed according to the resistor and therefore the vibrating frequency can also be changed. In addition, the driving device 32 is covered with a cap 3221.

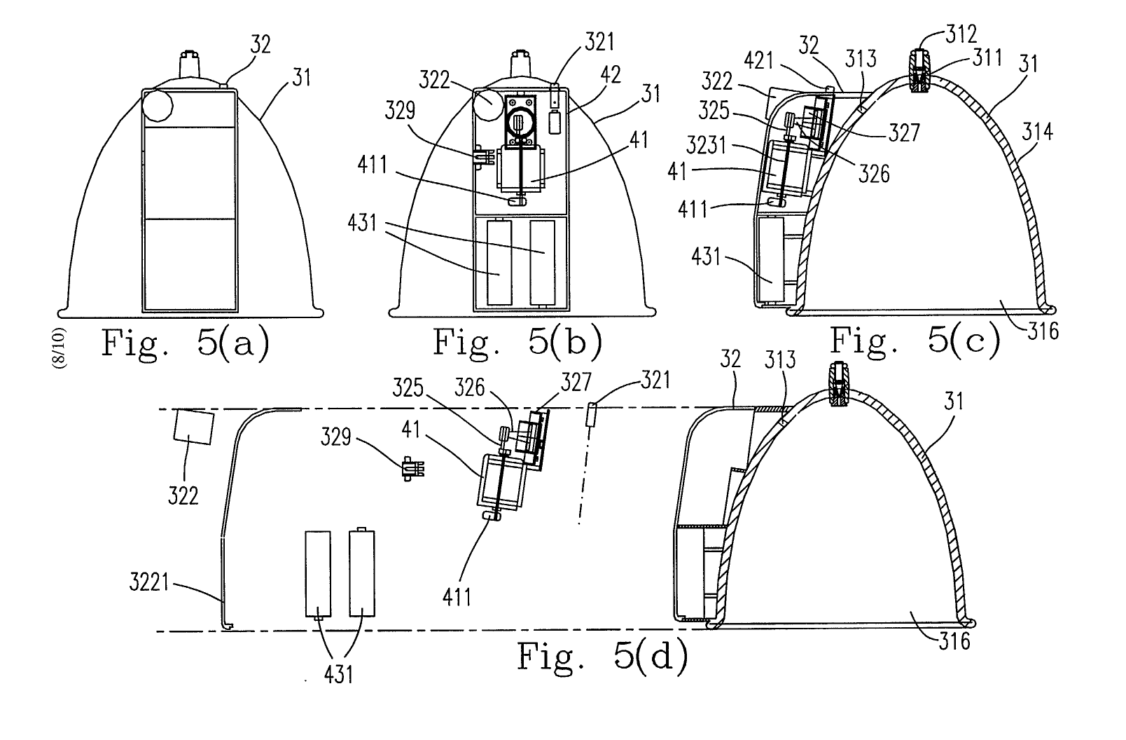

FIGS. 5(a) to 5(d) show the device for performing the can sucking therapy according to the second preferred embodiment of the present invention. The major difference between FIG. 3 and FIG. 5 is that there is only one motor 41 in the driving device 42. Most elements shown in FIG. 5 are the same as those in FIG. 3.

The driving device 42 includes a motor 41 having a shaft 3231, a first eccentric shaft 325, and a sucking pump 327. The first eccentric shaft 325 is connected to one end of the shaft 3231 so as to perform the eccentric motion when the shaft 3231 is rotated. A rod 326 is connected between the first eccentric shaft 325 and the sucking pump 327 for driving the sucking pump 327 to draw air within the can body 314. A second eccentric shaft 411 is connected the other end of the shaft 3231 to serve as the vibrating device. When the motor 41 is operated, the can body 314 will be vibrated according to the eccentric motion of the second eccentric shaft 411. Meanwhile, the sucking pump 327 will draw air within the can body 314 according to the eccentric motion of the first eccentric shaft 325. The power of the driving device 42 can be supplied from the electric socket 329 or the battery 431.

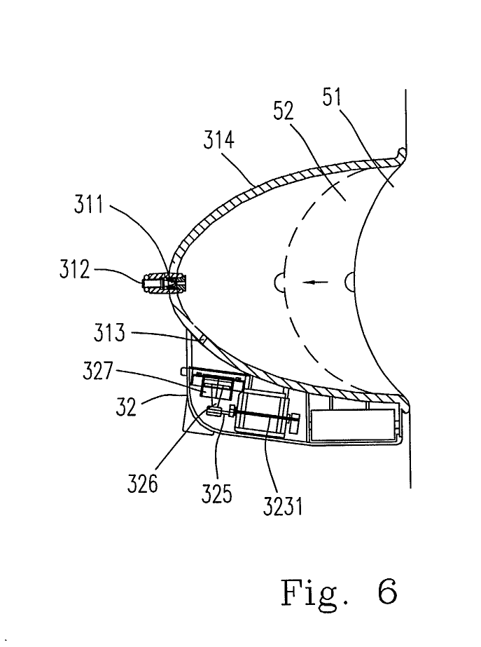

Please refer to FIG. 6. The device of the present invention is applied on a user's breast. When the driving device 32 is in operation, the sucking pump 327 will suck air within the can body 314, and the muscle of the breast 51 will be expanded and plumped up. After several therapies, the user may have a buxom breast 52.

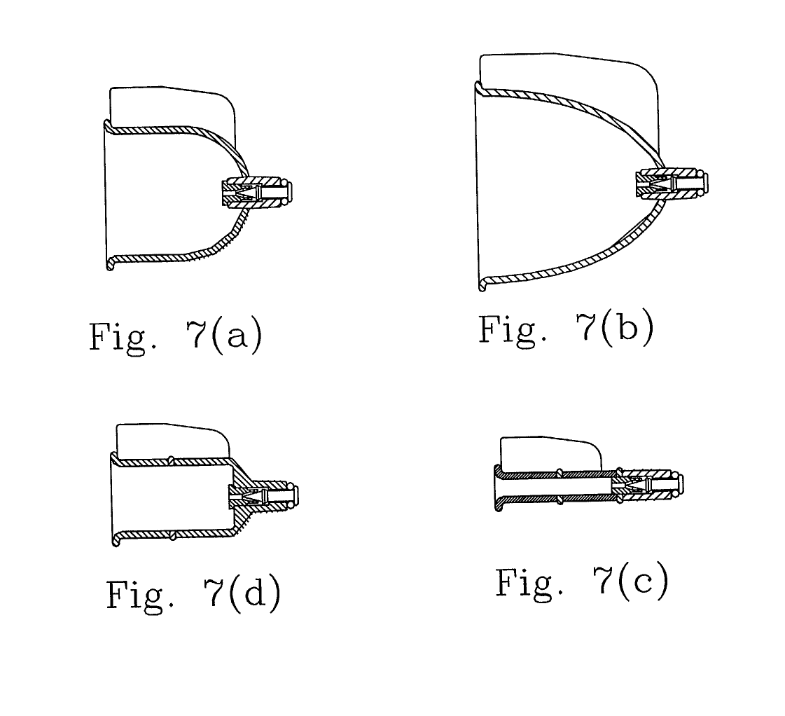

Please refer to FIGS. 7(a) to 7(d), which show different types of the rigid can body. These can bodies are made in different sizes. Different can body can be applied on different portion of the user' body.

In conclusion, the device of the present invention is used to perform a can sucking therapy with a vibrating mode. The device includes a main body applied on the user's body and a driving device to draw air from the interior of the main body so as to form a negative pressure state within the main body and vibrating the main body. The pump inside the driving device can be used to suck air inside the main body for performing the can sucking therapy. Therefore, the device can perform a massaging function on the user's body so as to achieve a better curative effect of the can sucking therapy. It is understood that the device could be performed by oneself conveniently and only little space is occupied.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What we claim is:

1. A device for performing a can sucking therapy, comprising:
a can body having a first opening, a second opening and a third opening defined therein;
an automatic sucking device connected to said can body and communicating with said first opening for drawing air from an interior of said can body to form a negative pressure state within said can body when said second opening is sealed against a portion of a body;
a vibrator mounted on said can body for vibrating said can body; and
a valve arranged in said third opening for preventing air from entering said interior of said can body when said valve is turned off and allowing air to enter said can body when said valve is turned on.

2. The device according to claim 1, wherein said automatic sucking device further comprises:
a first motor having a shaft;
a first eccentric shaft connected to one end of said shaft for performing an eccentric motion when said shaft of said first motor is rotated;
a sucking pump communicating with said first opening for drawing air from said interior of said can body to form said negative pressure state within said can body; and
a rod connected between said first eccentric shaft and said sucking pump for driving said sucking pump to withdraw air from said interior of said can body.

3. The device according to claim 2, wherein said vibrator is a second eccentric shaft connected to said first motor for vibrating said can body when said first motor is operated.

4. The device according to claim 2, wherein said vibrator is a second eccentric shaft connected to a second motor for vibrating said can body when said second motor is operated.

5. The device according to claim 1, further comprising a controller for controlling a vibrating frequency of said vibrator.

6. The device according to claim 1, further comprising a power supply for supplying electricity to said automatic sucking device and said vibrator.

7. The device according to claim 6, wherein said power supply is one of a battery and a commercial power supply.

8. The device according to claim 1, wherein said automatic sucking device is capable of being taken off from said portion of said body when said valve is turned on.

9. The device according to claim 1, wherein said can body further comprises an one-way valve arranged in said first opening for preventing air from entering said interior of said can body so as to maintain said negative pressure state with said interior of said can body.
